(19) United States
(12) Patent Application Publication
(10) Pub. No.: US 2014/0207840 A1
(43) Pub. Date: Jul. 24, 2014

(54) SYSTEM AND METHOD FOR PROCESSING REAL TIME DISPLAY OF CHANGES TO DATA TRIGGERED BY CHANGES IN A DATA SUPPLY CHAIN

(71) Applicants: Stanley Benjamin Smith, Charlotte, NC (US); Lyndon John Smith, Leicester, NC (US)

(72) Inventors: Stanley Benjamin Smith, Charlotte, NC (US); Lyndon John Smith, Leicester, NC (US)

(73) Assignee: Stanley Benjamin Smith, Fort Mill, SC (US)

(21) Appl. No.: 13/749,253

(22) Filed: Jan. 24, 2013

(51) Int. Cl. H04L 29/08; H04L 29/06

(52) U.S. Cl. CPC H04L 67/306; H04L 65/602
USPC 709/201

(57) ABSTRACT

The present invention is directed to a method and system for conducting one or a plurality of scenarios, simulations, games, or sport in which a plurality of participants are able to designate or “draft” or be assigned a set of assets, such a football team or basketball team or a set of military assets. Participants are further able to alter allocation of said assets according the rules and processes for reallocation of said game, sport or simulation in a real time crowd sourced pervasive computing environment. Statistics and real time audio and video streams and other data postable into mashups associated with said assets are updated in real time as they are captured, recorded, and distributed using a variety of transmission methods available to a pervasive computing environment. Said updated statistics may be transmitted by a third party such as a media outlet or through one or a plurality of social networks into which said participants are registered or enrolled.

### BACKGROUND OF THE INVENTION

1. Field of the Invention

Ubiquitous computing environments have created new opportunities for collection and distribution of real time streams of data, including multi-media streams with video, audio, and photographs. Resulting from improved opportunities for collection and distribution of data are benefits for homeland security, medical research and treatment, training and educational institutions and other users, particularly those who use real time streamed data. The ability to view multimedia mashups of streamed data along with other static data in situations where real time information is accessible will save lives and prevent tragedies.

2. Description of the Related Art

Ubiquitous computing environments are rife with data that is often sporadic or intermittent, and sparse (not necessarily distributed in large data tables or datasets). Smith (Ser. No. 12/932,798) introduces art that is well adapted to processing sparse and sporadic data, but does not leverage a capacity for display or for real time streaming. The new art of the invention herein folds streamed data into data management of intermittent and sporadic data within a data supply chain, and thereby enables appropriate responses and immediate utilization of data. This can be especially advantageous for processes such as homeland security risk assessments, medical procedures that benefit from real time tracking of data from multiple electronically enabled medical devices, in-course correction of business strategies, educating and informing decision makers, and even for entertainment domains such as fantasy football league play.

It is the purpose of the invention described herein to provide a system and method to leverage the data supply through triggered sequential or simultaneous display of data and/or multimedia files subscribed to or assigned to a data consumer. These are commonly called mashups. Each user of the system and method will be able to set up a unique configuration for live streaming of mashups of multimedia data as well as static data from databases or other datasets. The field of multimedia integration to create new or hybridized data formats and enable new functionality is still emerging. Mixing or recombining different kinds of information requires complex synchronization. The emerging discipline to achieve this is sometimes known as multimedia hybridization and there are current efforts to develop computer readable language codes to standardize the building and delivery of mashups. The invention described herein will utilize multimedia hybridization methods and tools as they come online.

Smith has been evolving art to enable the data supply chain and the system and method described herein may be applied to any entity described in Smith (Ser. No. 12/932,798) as either a “Subscriber” or “Client” with a relationship as a source or target for data of any type included into a data supply chain. These data supply chains are commonly associated with a “pivot hub” or an entity that accepts, records, and implements server actions upon changes in real time to the data supply.

A data consumer or “user” for purposes of the invention described herein is expanded beyond that of a subscriber or client as in Smith (Ser. No. 12/932,798) to include any user of the system and method of the invention who has enrolled themselves or registered as a user of one or a plurality of data supply chains and built a configuration profile to implement the method of the invention. An additional class of user is one who is already enrolled as a user of the triggered notification process described originally by Smith (U.S. Pat. No. 7,860,760) or is a user of any other triggered notification system or method for initiating or triggering forward or backward chaining of server actions (including initiating API's) or posts into datasets, data stores, or data streams. The method for enrollment of a user may be the one invented by Smith (U.S. Pat. No. 8,271,346) or any other systems and methods that enable enrollment of users to be contributors of data (sources) or consumers (subscribers, clients, users) of one or a plurality of data streams generated through a data supply chain process.

In Smith (Ser. No. 12/932,798), art for a system and method for selection of sources of data and for selection as targets for additions of data (these are labeled as “hubs”) is introduced to enable rapid transitions from one target to another and to enable said targets to become sources for data input. The ability of a user of the system and method to shift or convert a “hub” or target of data collection into itself a source of new data enables tremendous flexibility for designing and adjusting research processes in real time for new situations or contexts. Military and medical scenarios and simulations lend themselves to said rapid transitions, especially when tactical and strategic adjustments require rapid reallocation or utilization of assets or resources included in said scenarios or simulations—or even in emergencies in real time.

This hub and source capability is not intended to be restrictive for the system and method of the invention herein, and other art that enables selection of targets for data collection and sources for collection, input, adjustment or modification of said data can also be utilized to implement the system and method of the invention described herein. For embodiments of this invention, targets for data collection may be homeland security assets, medications or drugs undergoing clinical research trials or processes, players on a real or fantasy sports teams, inventory required for a business, equipment or employees associated with a business entity or activity, or products or services that might be acquiring user ratings or other observations from distributed or crowd sourced questionnaires or data input and collection utilities. For the invention described herein, NFC devices, gaming consoles, emails with embedded video, and other of the plethora of electronic devices capable of processing computer readable code can be both targets and sources for data streams.

The introduction of video and audio streaming capability gave rise to a need for new art to conflate or integrate historically standard formats for data from data aggregators or federators with real time data from live data sources, such as said streams of audio and video data. When data is posted upon screens of devices associated with the method of the invention described herein, in mashups or in dashboard or other electronic display formats, the user of the method is better able to react appropriately, especially if tactical or strategic decisions are to be made. The invention described herein introduces art to apply triggering to streamed and static data integrated into a data supply chain. The principle that a portion of a dataset can be extracted and used to trigger server behaviors was introduced in (U.S. Pat. No. 7,860,760) and new art to expand application of that art to assets associated with a simulation or scenario is included within the invention described herein.

A system and method of Smith (Ser. No. 13/136,421) introduces art to fold data streams generated through the intrinsic operation of any electronic device or sensor capable of implementing computer readable into the data supply chain. Further art introduced by Smith (Ser. No. 13/200,073) also enables inclusion of datasets from standard data federators or aggregators as well as from social networks, Wikis, and other sporadic intermittent generators of data into the data supply chain. Smith (Ser. No. 13/567,084) further introduces art for tagging and extracting strings of real time streamed data for inclusion into a data supply chain. To improve data quality, Smith (Ser. No. 13/545,891) introduces art for iterative vetting and validation of data for inclusion into a data supply chain from crowd sourced networks. Smith (Ser. No. 13/545,891) further enables research or data accumulation protocols to be improved iteratively with the aim of ensuring that data posted into a data supply chain has an increased potential value for research through structured assignment within a data collection protocol and clearly delineated attribution with those who construct, vet, and validate said protocols. That patent (Ser. No. 13/545,891) also monetizes contributions to the data supply through methods for including payments and incentives to those who improve protocols, such as researchers and domain experts.

Art to incentivize contributions of data by weighting data by popularity, by reputation of the source of the data, and by topical priority to enable calculation of value for monetization has also been developed by Smith (Ser. Nos. 12/930,280 and 12/932,798). Another supporting invention by Smith (Ser. No. 13/200,073) to encourage and monetize data trading itself, is a system and method to lock a dataset while it is being traded; thus enabling each subsequent owner of a dataset to leverage and improve and evolve it on his own behalf, but the original creator generator or provider of the data is compensated for his originating dataset.

In each invention cited herein, property rights for generators or creators of data are reflected by inclusion of methods for determining prices or fees or social rewards or incentives for participation in data creation or exchange, operation of systems or methods for data exchange, or for data itself. Smith (Ser. No. 12/932/797) has even developed a system and method for including pricing and fees for use of a GUI when data is exchanged or traded. The larger objective for the series of inventions by Smith is to enable, facilitate, and encourage data trading for all data creators and all data consumers within a free fair and transparent market.

Prior art to provide necessary and sufficient conditions for the system and method of the invention described herein and used to develop the search logic and search terms for discovery of prior art includes:
1. The introduction of pervasive or ubiquitous computing environments that include multiple servers and devices and electronic sensors associated with distributed users.
2. The introduction of crowd sourcing and social networks, so distributed and ubiquitous computing environments can include non-technical users of devices or servers capable of running computer readable code and enabling broad sourcing of video and audio and other data streams and datasets.
3. Hierarchical authentication and role assignment schemas to order user rights and assignment to functions such as sponsor, manager, participant, auditor, and so forth.
4. Enabling banking and other financial transactions to be managed and implemented through the internet.
5. Computer games that increasingly fold in asset allocation capability, such as Sid Meir's Civilization, that simulate and real world activities and actions and require users or players to allocate assets strategically and manage consequences resulting from said allocations.
6. Broad distribution of NFC enabled or capable devices so rewards and other actions—flashing lights, dispensing a beer, distribution of funds from an ATM, etc. are available to improve or diversify or enrich the immersive quality of the user experience.
7. Increasing use of computer driven scenarios, such as fantasy sports leagues, military exercises, computers (IBM's Watson) that play Jeopardy, and so forth.
8. Real time streaming of multimedia and other data and the evolution of video and other media sharing crowd sourced or social networks.
9. Posting of data within a mashup or a series of mashups or in alternate places upon a single screen or distributed across multiple screens.
10. Real time propagation and distribution of changes to data using email, gaming consoles, or other internet linked devices.
11. Cloud storage in servers and devices able to combine and post and store data from different purveyors, creators, or distributors so data can be broadly sourced in many formats and processed rapidly.
12. Expansion of search algorithms and capabilities to data sources and stores other than web pages.
13. Advances in user interaction and data visualization and presentation such that real time and historical data can be displayed on the same sectionalized screen and a user can interact with the data through mouse clicks or use of touch screen technology or gesture or voice commands or other methods.
14. Advances in triggering upon data, including enabling participants to build and set triggers and trigger conditions, propagation of triggers, use of triggers to initiate API's, assignment of triggers for or to various roles, and enabling selective distribution or access to triggers

### BRIEF SUMMARY OF THE INVENTION

The new art disclosed herein for the data supply chain involves combining historical data with real time data regarding the performance of assets to better inform strategic and tactical decisions across many domains or endeavors. It further introduces art for triggered mashups unique to assets assigned to participants and enables the monetization of contributions to a mashup unique to each user from each purveyor or entity generating real time streamed data.

All the inventions cited above implicitly and explicitly center upon the intersection of data with research tools and methods. Similarly with the invention described herein. Before the evolution of pervasive computing, the possibility for converging historical and real time data was not available. NFC devices and streamed video and audio were in their infancy and standardization and conventions for formatting of data were primitive. A lack of standardization reflected by multiple file formatting conventions and a multiplicity of codecs made data sharing and exchange problematic and labor intensive. Real time streaming of data as video or audio or other data was produced was limited to separate and disconnected processing methods or options as those skilled in the art were evolving tools and methods to address both the hardware and software issues involved. Memory itself was at a premium in those days, so changes in infrastructure and data transmission speed and access were needed to make the system and method described herein practicable.

The last few years have changed the landscape, and the art of the invention described herein can now articulate a system and method for achieving a convergence of historical and real time data regarding assets within the context of a data supply chain as disclosed by Smith in the series of patents cited above the background of the invention.

If data can be extracted from an existing data supply and merged into an evolving data supply chain of streamed sections or segments of audio and video and alphanumeric data regarding assets; systems and methods for scenario construction, simulations, and other embedded real time research processes can evolve and improve. Simulations and scenarios are relevant to many fields of endeavor and many information rich or information dependent disciplines. They commonly pivot around a group of participants (investigators or users) using variable assets and strategies to address a common complex task requiring strategic and tactical decisions, usually related to a constrained set of assets. Each asset carries with it a set of specifications. In the case of a football player, it may be his height and weight and running speed. Each asset additionally carries with it a history of performance. In the case of a football player it may be the number of passes caught, the number of interceptions, the yardage gained or lost per play, the number of quarterback sacks per game, and so forth. Analogous or comparable data may be available to a military commander regarding his individual soldiers, his military units, equipment allocated to his units, his supply line, and so forth. Much of this data may be available or housed in some data storage medium accessible to the football coach or the military commander or any user of the system and method of the invention described herein.

When a live scenario or simulation is managed or implemented, the entity or participant or user managing the scenario or simulation interprets emerging data and initiates actions to adjust allocation and distribution and use of assets in order to maximize his likelihood of achieving a better outcome, often in competition with other participants or users. Often alternate or competing scenarios are operated simultaneously to enable identification of better allocations of resources and better strategies and tactics to generate best practices protocols. If the scenario participant is able to automate and set triggers for server actions and responses in anticipation of likely events or choices to be made, he is freed up to address unanticipated emergent issues as the scenario unfolds. This automation of some decisions, provided the preconfigured trigger conditions can be adjusted as needed, enables a more finely tuned response to emerging events within the scenario or simulation. The quality of decisions may improve more rapidly and be documented more precisely through use of the system and method of the invention. This can be of significant value when assets involving homeland security or business viability or sustainability come into play.

Creators of computer games have been enabling art to implement scenarios and simulations as they create their “worlds.” Indeed, games such as Civilization and Sim City present many choices and alternatives for allocation of assets and are even used to train or evaluate leaders and managers in various fields in an effort to have them apply and evolve skills to lead and manage their organizations in the real world. There are many advantages to running simulations, not the least of which is the absence of actual damage or loss when errors in judgment are made that could have terrible consequences if the scenarios were real. Developers of role playing games with multiple players have created impressive advances in scenario or simulation mapping and provide an increasingly immersive experience for the players or participants. The actions of players within these computer games are fed into various decision trees that often have trigger conditions that will shift the direction and process of the game. However, these are closed circles, and “real” world data is not currently intrinsic to the process or play within the game. The invention described herein remedies that.

Among the first intersections of fantasy scenarios with the real world was the emergence of fantasy sports leagues in the late nineties of the last century and still evolving today. Typically a fantasy sports team participant or “owner” will select his own team from a group of available “players”—these players being actual players currently (and in a few instances historically) assigned to real teams within a real sports league. Participants in the scenario of a fantasy sport combine known historical data with their intuitive and instinctive judgment of the capabilities of their assets (rosters of players) as compared against the capabilities of the assets of the opposing team. Estimations and calculations upon data derived from an asset's past performance or the effectiveness of alternate strategies utilizing an asset's capabilities are pitted against a rival or a competitor's estimations and calculations. For the purposes of the invention described herein—“players” are expanded into a class of members we call “assets.” Participants (users) make simple calculations or evolve complex algorithms, implicitly or explicitly, to estimate the impact of a given asset or strategy and then configure and distribute these assets and implement their strategies. The actual performance of these assets in actual games occurring in different locations on different real teams and at different times is correlated with those of the set of assets on the fantasy team. These correlations then determine which fantasy league teams will prevail on a given day. The excitement of the game for the fantasy league “owner” is to discover whether his ability to predict the performance of his assets, or (in advanced versions of these games); whether the implementation of his strategies for use and allocation of those assets will prevail over those of the assets of one or more competing fantasy teams his team is pitted against.

Selection of the assets and assignment and reallocations of the assets are a crucial aspect of these fantasy leagues, and much energy is expanded in evaluating prior statistics for assets and estimating the balance of assets on the fantasy teams. Deciding which “player” to draft onto a team roster is a major part of the scenarios and much inventive effort has been expended to develop methods and systems to calculate the better choices when a window to draft players into a team is open. Each play or game sequence within each real game played in the real world leads to an adjustment to the statistics of the players that are also assigned to a fantasy league team, thus changing their value within a draft window, as well as changing their value to the fantasy team in real time.

What does not currently exist in fantasy league play or indeed in most simulations and scenarios is the ability of a user or participant in a scenario to adjust the assignment of assets in response to both the historical and real time performance of said assets responsive to extracted video or audio or other real time streamed data from multiple purveyors and sources. The invention disclosed herein applies to and advances art for simulations across multiple fields of endeavor, such as simulations within military training exercises, simulations of the evolution of and growth and demise of businesses, simulations of marketing campaigns, simulations of biological or physical systems, distributed assessment centers, and so forth.

### BRIEF DESCRIPTION OF THE DRAWINGS

FIG. 1. “Diagram of System Components” diagrams how the system and method connects participants to devices and entities and to data transformation and processing methods and to operations and transactions.

### DETAILED DESCRIPTION OF THE INVENTION

The new art of the invention described herein enables use of a pervasive computing environment with crowd sourced participation to process both live real time data and historical data associated with real world assets to improve prediction of outcomes or test hypotheses or assumptions or estimations regarding the performance of assets or entities. When hypotheses about performance of an asset or entity from experiments or scenarios is conflated or combined and confirmed or denied by actual data, something magical and important results—new knowledge. Triggering of events and actions across networks responsive to changes in data associated with an asset included into a data supply chain enables the researcher or user or participant in the scenario process to focus on larger strategic or tactical considerations because the burden of standard and readily apparent responses to anticipated events is managed through triggering and resulting server actions. An iterative improvement in best practices can then be determined based upon results.

Traditional sourcing of data is commonly from individual human actors making entries into data collection forms or protocols or computers posting data into data tables. If data sourcing is expanded to enable searches conducted on search engines, through parsing video and audio streams for relevant data for inclusion into a data supply chain (Smith Ser. No. 13/567,084) or through automated posting of data from devices like NFC devices or sensors (such as heart rate monitors, RFID tags and so forth (Smith Ser. No. 13/136,421) or other automated data capture for inclusion into a pervasive computing environment, then a system and method for multiple continuous dynamic simulations is enabled. Additionally human actors need to be able to select and allocate assets within a scenario responsive to shifts or changes in the value of an asset in accordance with its current performance in real time, or as a consequence of a change in the configuration of or inclusion of other assets into the scenario. Preconfigured triggered actions enable a participant in a scenario to make judgments on a more strategic basis. This can be a significant advantage not only to the user of the invention described herein in competitive scenarios such as fantasy sports, but a crucial capability for the homeland security or military strategist.

Several problems consistently disrupt or prevent continuous collection and real time distribution and utilization of streamed data associated with assets when the data is distributed across many locations and collected from many entities that do data provisioning, purveying, storage, processing or generation:
Data collection and distribution may be inconsistent depending on the purveyor's processes and distribution methods.
Crowd sourced enrollment of contributors can be complex, especially when social networks and NFC devices are included into the data supply chain.
Data is in multiple formats and may not be readily converted into formats for uniform display or visualization.
Data transmission is sometimes delayed and that delay may cause the data to lose value or utility for decision making regarding strategies or tactics or accurately calculated or correct interpretation of results.
Collection is intermittent (a data collection or transmission entity may operate upon its own schedule) and incoherent (continuity and real time translation and extraction across data types and formats is still in development).
Data is insufficient, for example, patients know most about the impact of the drug on them, but do not usually have the tools or access or training to know how to contribute that information in real time or in a structured manner.
Intervening variables associated with an asset or a dataset, such as damage or injury, can significantly impact interpretation of the collected data.
Data input does not conform to regulatory standards or requirements.
Algorithms or tools for triggering actions based on data available to risk managers are not readily available and not pre-programmed or preconfigured, leaving a gap between the event and the response of a strategist or tactician that may be too long to address other cascading issues emerging within the scenario or simulation.

A partial solution to these constraints or concerns involving simulations or scenarios is available through the system and method of the invention herein to fold in extracted sections or segments associated with assets from distributed streams of data in real time into scenarios and simulations. Enabled through the system and method are capabilities to:
Post/offer and discover data associated with assets to one or a plurality of distributed servers or devices;
Push and pull data associated with assets, including multi-media data from a full circle of data purveyors in real time;
Utilize existing and emerging mashup combinatorial tools to instruct servers or devices to combine data into mashups;
Trigger collection and posting of mashups and dashboards or other data posts according to user specifications through configuration profiles;
Provide a self-service configuration interface for simple triggering upon achievement of threshold conditions associated with assets within streamed data;
Use triggering to initiate backward or forward chaining of server actions;
Automate dashboard or other screen postings upon screens or displays upon servers or devices;
Automate SMS or Email or other messaging regarding status changes of individual or grouped assets or performance of said assets according to user specifications through configuration profiles;
Leverage social networks for collecting data regarding assets to use within mashups;
Enable propagation of asset allocation and configuration profiles throughout a user network or set of servers or devices;
Utilize both static and real time data within mashups or on screens of servers or devices associated with a user:
Post, link, and store mashup logs and history to research or quality control datasets;
Collect transaction fees and do banking or fund transfers in accordance with the offer and/or acceptance terms associated with an asset allocation and configuration profile;
Update and accept changes to asset allocation and configuration profiles from users.

The system and method enables a sponsor or vendor or coordinator of a scenario or simulation process, such as a fantasy football league administrator to structure and sequence a series of unlinked individual data sources or data sources linked in a series or linked through crowd sourced data sourcing mechanisms or a combination of these for collection and distribution of data from and to users of the system and method of the invention described herein. This also includes data from entities involved in professional or commercial production of media or other data files. At least one of the devices associated with the process will be capable of processing computer readable code to transmit triggered mashups and updated statistics directly to linked servers or devices or alternatively to transmit mashups and updated statistics across social networks to allow or enable enrollment of participants or users into a scenario or fantasy sport or simulation or game.

The sponsor or coordinator may designate which assets may be available or assignable to a participant. However, there are many alternative methods for assignment such as a draft system for the fantasy sports league, or an auction platform for bidding for an asset, and so forth. It is not in the purview of this invention to structure processes and methods to use for identification of assets to be included, but only to affirm that assets are assigned according to the rules and methods intrinsic to the discipline or field for the coordinating or sponsoring entity. The system further enables a participant or user to build a configuration profile for assets assigned to him as part of the scenario building process. These assets will vary depending on the type of scenario or simulation, but the user will input instructions to identify, select, tag, combine, recombine, and transmit selections of one or a plurality of combinations of one or a plurality of assets into the configuration profile. Thus, the configuration profile confirms the assets that the user is including into the scenario.

Another aspect of the configuration profile, if the participant or user is provided access to information about assets assigned to an opposing participant or user, is the ability to designate data capture for assets that will be or might be placed in opposition to his own assets in the configuration profile in preparation for the unfolding of the actual real life scenario or simulation. As the scenario or fantasy sport or simulation or game unfolds, data associated with the performance of assets associated with the configuration profile is updated in real time via extraction and posting of the data as the assets perform in actual sports or games or simulations in the real world. Thus, streamed video or audio of a series of live football or basketball or baseball or other sports or games or simulations can be parsed for references to one or a plurality of the assets allocated to each participant in various combinations and permutations according to the scenario or simulation for that event; and sections or segments of data can be extracted for mashups and revisions to statistics associated with each asset through updating procedures for transmission and posting directly upon devices associated with the participant. The participant in the scenario or fantasy sport receives video and audio mashups regarding his assigned or designated assets and posts of updates of statistics associated with their players (assets) so real games or events feed fantasy games or simulations simultaneously.

In the case of this embodiment, the set of actual games played with live athletes provide the raw data and the video and audio streams in real time as the games unfold. Data is captured and transmitted by media outlets or other entities that are recording and transmitting live events in real time. As media outlets transmit video, audio, and other digital data, such as performance statistics associated with these assets (players), the value and attributes of the players on the fantasy team are updated. Thus a set of assets (players) for a user or participant may be pitted in competition against those of a second participant or multiple participants, enabling unique display and packaging of the mashups of asset performance for each asset assigned to a given participants, as well as updates of statistics associated with the assets. As these are posted to the screens of devices associated with participants, participants adjust their rosters and tactics for the next series of plays or sequences in accordance with the rules of the sport or game or simulation with the object of their fantasy team winning the game or scenario. The hiatus in action between the scoring of a point or a goal or a basket or other marker of an end of a sequence of play provides the participants with a window of time in which to update or change their rosters or lineups or call plays or select other strategies to be tested on the live field of play by the athletes (players or assets) that are playing in the live event(s). These hiatuses in action or gaps in time between real time performance of assets may also be leveraged by video or audio or other data streaming entities to insert advertising into the “dead” spaces in the action unfolding in the scenario. These dead spaces may also be filled with tips or hints or other informational or educational “filler” that enhances the participant's experience and improves the participant's performance within the scenario or game or simulation.

Reconfiguration of the configuration profile for a user or participant may be accomplished at any point in the scenario, simulation, or game if enabled by the sponsor or coordinator or entity that sets the rules for changes to lineups of assets. Further, the coordinator of the fantasy league contest may implement a notification or an alert to a participant or user of changes in the lineups, or penalties, or infractions of rules, or injuries to assets, or other events that involve assets on opposing teams; thus enabling the participant to adjust their own lineups in accordance with changes in status or allocation of opposing assets. Updates can be broadly distributed and broadly sourced through social network gateways or websites or software as a service providers or cloud storage and hosting providers or through broadcast transmission and streaming from television networks or stations in formats viewable upon devices accessible to a participant or user.

While a fantasy football league has been offered as an example of an embodiment and may be further understood in the explanation of the system and method that follows; any simulation or scenario can be described in a similar fashion and embodiments of the invention are not restricted to fantasy sports leagues. The embodiment being described for fantasy football applies to scenarios or games or simulations with the following conditions:
1. Upon enrolling as a participant, the participants may build a configuration profile that selects or tags assets from available lists or groups of assets, or the participant is assigned a set of assets to allocate within one or a plurality of simulations or games. As the system operates, each participant can respond to updates of the performance of their assets or strategies; and, within the parameters or rules established for the simulation or game, may reallocate or alter the inclusion of assets, roles of assets, assignment of assets, and strategies to apply within the scenario or simulation.
2. The scenario or simulation has at least one break in the action or sequence of play long enough for one of the devices of one of the participants to accept and post changes the configuration profile and thus to his roster(s) or lineup(s). In some embodiments, changes in strategy or non-human assets may be posted into a device that can accept changes in multiple classes of assets or multiple strategies.
3. Statistics or data regarding players or other assets or strategies included in the game are maintained and updated and can be known prior to the game for the participant to consider as he assigns assets to a lineup or roster according to the participant's judgment or intuition. These statistics or data can be a combination of real time updates as well as historical data about the performance of assets on the roster or lineup.
4. Statistics or data regarding players or other assets or strategies included in the game can be transmitted and posted to a device accessed by at least one of the participants in the fantasy game or simulation.
5. As the assets perform in real time the configuration profile instructs or informs data transmission or data receiving or processing devices and equipment to parse their transmissions for assets listed within user or participant configuration profiles and extract those segments for transmission. These extracted sections or segments of data are then streamed to a device associated with the participant or user for viewing. Alternatively, an intermediate server or sets of networked devices or servers may perform the extraction of the relevant sections or segments of data, providing permission from the transmitting entity is obtained.
6. For social network members, it may be possible to bypass standard media channels and post their self-generated data streams to an intermediate server for distribution or use peer to peer networks. Data from multiple actual games or simulations can be streamed by media or social network members attending the games or other entities with rights to transmit live events, games, or simulations they may be attending or viewing—or even participating in. Extraction of relevant sections or segments of data can be done by the member of the social network on a piece by piece basis, but it is more likely that a data parsing engine enabled to match assets across configuration profiles of members of the social network will be used.
7. The streams of data and other updates may be confined to portions of the display screen on the device associated with a user or participant, thus enabling a user to simultaneously use the display space for other purposes, such as to watch other live games of interest, perform calculations or other activities to inform his adjustments to the configuration profile, and so forth.
8. Any video and audio sharing social networks or entities can be folded into the system and method of the invention described herein. A particular advantage of this capability, is the ability of a person participating as a player in the live event or game to be in communication with one or more participants in the fantasy or scenario or simulation, and receive coaching or instruction “on the fly” to improve their participation in the live event. Mechanisms or processes for aggregating and shaping these crowd sourced inputs for the live event participant are variable, but it is a unique feature of this invention to enable the fleshing out and expansion of an available data supply to combine and structure input to inform and improve performance of a player “on the field.”
9. A participant may modify allocations of assets or designate alternative strategies in order to leverage the performance of single or grouped assets against those of an opponent in order to win within the rules of the scenario or simulation or game. A second participant or a plurality of additional participants will customarily have options equivalent to those of said first user.
10. One or more electronic devices may be pre-programmed to function as participants. For embodiments using this capability, the participant using the system and method would function like some chess players who engage many opponents at a time, thus improving both speed of response and judgment as well as complexity of the scenarios being managed.
11. Transmissions of real time or near real time video, audio, or other data streams containing sections or segments of data regarding updated performance of assets being allocated within the simulation or game are posted and viewable on the one or a plurality electronic devices as dashboard or other postings of statistics and as video mashups according to rules and rights for data distribution to participants in said simulations or games.

Art described in the patent herein will enable homeland security agencies to run simulations that are more realistic because strategic decisions and their consequences can be enacted in real time by real persons; bypassing the potentially limiting algorithms that drive simulations from self-contained constrained and rule bound computer programs. Scenario or fantasy sports team “owners” will be able to alter their “lineup” in response to the lineup of the opposing team through real time responses to updates of performance of their assets compared to the real time updates of the performance of the assets allocated by their counterpart for the opposing team immediately upon completion of plays or actions or events associated with said simulations or games; or may make adjustments in the course of play itself in scenarios and simulations that lend themselves to emergent adjustment.

The excitement of real time real world consequences from coaching and managing assets within a competitive context provides a psychological reward for participation in a fantasy league or for an audience observing choices and decisions of managers or coaches. Viewing mashups of the performance of the fantasy team immediately will bring the scenario or fantasy sport game to life and make it possible for various configurations of televised streaming of events and adjustments to statistics to successfully entertain fans of sports that have built an infrastructure to enable membership in fantasy leagues. Increased audience engagement will result. An embodiment of the invention will include the role of an audience member who does not participate in adjustment of configuration profiles, but is privy to display of the reconfigurations and other decisions of participants in the scenarios or simulations as well as witness to the mashups and screen displays on devices associated with participants in the scenario or simulation. An example of this kind of process is the way in which the audience witnesses the play of poker players in televised poker competition events.

One embodiment of the invention described herein will enable a “round robin” crowd sourced distributed competition that can lead to a national championship in the sport or scenario or simulation in question. Each owner or coach or manager or captain of a team can field his team and adjust his asset roster just as the owner or coach or manager or captain of a real team can. An embodiment of the invention described herein will enable monetization of participation through enrollment fees, advertising revenue from ads streamed along with statistics updates and streamed mashups, and fees or payments for rights to implement the art of the patent described herein from media outlets, such as television production organizations and sports broadcasters and other outlets that stream said contests in tandem or parallel to the “real” games being aired by one or a plurality of said media outlets during said games or simulations.

Multiple variants of embodiments of the invention will enable entities sponsoring the scenarios or coordinators adjusting or managing the scenarios to insert additional features or complexity. An example is enabling “side bets” or estimates of the success of the assets in the next order of play that can result in additional rewards or prizes or changes in rank or status for accurate prediction. Another example is enabling cross registration of a participant into multiple leagues, games, or simulations, and further enabling combined calculations of participant scores and rankings to be tallied to generate cascaded rankings and scores across leagues, games, or simulations. Yet another example is enabling selective transmission to one or a plurality of participants enabling alternate views and access to statistical data and to streamed video or audio.

Variants can also be enabled to facilitate monetization, such as embedding advertisements for products or services along with said streams of video and audio. Variable fee and payment structures for embodiments of the invention described herein may also be enabled, such as; charging a subscription or registration fee for access to updated statistics upon registration or enrollment or upon a per play or per game or per season (set of games) basis.

In some embodiments of the invention described herein, the entity or coordinator or a computer algorithm associated with the scenario may insert infractions of rules and penalties for infractions of rules, or injuries to assets in order to adjust the challenge and complexity of the scenario.

Triggers are an important intrinsic aspect of the invention described herein. The patent by Smith (U.S. Pat. No. 7,860,760) provided a framework for linking together data from multiple sources for evaluation by trigger formulae to initiate forward and backward chaining of server actions upon attainment of triggering thresholds; however, it did not identify how designated assets with data associated with said assets could be linked into a data supply chain. The inclusion of sections or segments of streamed data regarding assets and the combination of these sections or segments with other data tables and datasets will broaden the applicability of Smith (U.S. Pat. No. 7,860,760) to changes in assets included into scenarios or simulations or games. For scenarios and simulations and games, data regarding assets may be transmitted in video and audio codecs and the data may be extracted from tables or larger datasets. Triggers can be implemented upon changes in this data regarding assets and those triggers can enrich these processes. Triggers may also be generated through artificial intelligence algorithms. This can be particularly useful for those involved in robotics and intelligence.

Trigger design and implementation is through use of a GUI that accepts logic and calculation instructions for a trigger, then accepts threshold values for that trigger, and then accepts other forward or backward chaining instructions for server actions responsive to attaining the threshold value for that trigger. A GUI has been developed to implement Smith (U.S. Pat. No. 7,860,760) that uses a common and widely distributed and familiar calculator like interface with logical instructions and interaction with one or a plurality of datasets as described above to insert threshold values; however, many alternate GUI's can be developed to enable the trigger building and design process.

Triggers are variable in purpose, in structure, and in implementation. For instance, in fantasy football (which we will use as a case in point for triggering) triggers can be set off prior to a game or between games involving agent negotiations and contract offers to free agents, or to participate in and offer auction values within asset auctions for player contracts, or for participation in draft mechanisms offered by a fantasy league, or to initiate or terminate the assignment of an asset to a roster or lineup, or to change the position or location or assignment of an asset within a lineup or roster. Upon an event or a score by an asset within the scenario or game, a trigger can be implemented to set up a response such as the type of play (in football, it might be a “run” or a “pass”) or the pace of play or the direction of a play, or the asset assigned the ball in the following play or the risk level (e.g. length of the “pass”) for the following play. Triggers might also be set off by occurrences within the game such as player injuries, rule infractions. Other triggers might involve making assignments to special team or units upon event or occurrences, or upon passage of time or stage of play or location upon the field of play. The variety of triggers within a game or scenario or simulation is considerable, but all have in common a need for the participant to anticipate how assets might interact and what responses in allocation of assets would be of potential value.

Other triggers that may be included within a scenario or simulation or game are those involving side bets or bonuses or rewards that result from achievements within the larger parameters of the game. Side bets might involve a single play or series of plays or a segment of the game sequence like a half or a quarter. Triggers related to time or events might also include notification triggers to members of social networks or crowd participants. Even sponsors or coordinators might generate triggers to fund or monetize the game process itself, such as triggers for placement of ads into data streamed to display screens associated with participants according to their current demographics or rosters of assets, or history of participation or statistics within the game or league or simulation or scenario (such as length of membership or winning percentage), or their statistical records or their demographic data. Informational triggers to notify participants of rule changes or other information relevant to game play, or related to the status of the field or playing environment, or results of side bets, or reward or prize distributions can also be configured according to rights and roles. An important set of additional triggers relating directly to monetization are those that can be embedded into the configuration profiles by the scenario or game or league or simulation for calculation of fees or charges for membership or participation, for calculation of fees or charges for ad placement, or for initiation of fund transfers across financial institutions of fees and charges implemented by triggers in the process of one or a plurality of scenarios.

Along with the trigger setups are features common to managing and processing triggers intrinsic to the system and method, such the trigger design interface, retention of a trigger library and trigger formulae associated with the scenario or game or simulation or league as well as each participant, trigger propagation and distributions functions and server actions, storage of histories and logs of server actions accessible for data mining, and tools for process improvement activities for the system and method of the invention described herein. However, in all instances, the set of assets associated with the participant in the scenario or simulation is the determinant of the matches sought as data streams are parsed for relevant data segments or sections. Thus triggering for the invention described herein centers around the one or a plurality of assets included into the participant's configuration profile.

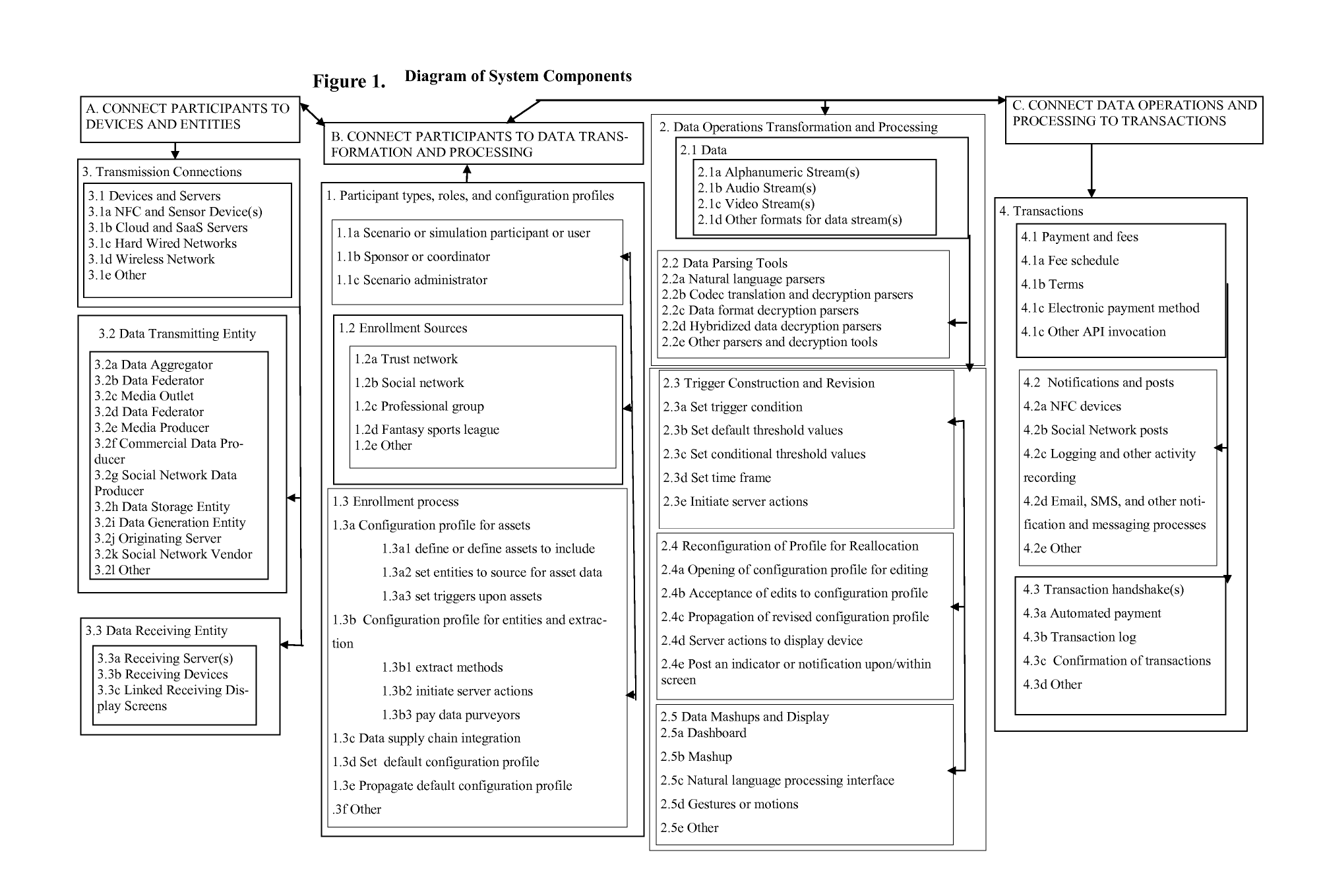

Diagram of System Components in FIG. 1 reflects one of many possible embodiments of the invention. It is expected that those skilled in the art would be able to construct and design alternate embodiments and FIG. 1 is a template from which said alternate embodiments would be derived. There are three primary functions that link the system components; those primary functions connect participants to devices and entities (A) associated with the invention, connect participants to data transformations and processing (B) and connect data operations and processing to transactions (C). Processes can be circular and can be initiated from any of the pivots (A) or (B) or (C), once the system and method are in place, but the initiation of the system and method begin with determining and assigning participant roles and types and establishing one or more variations of configuration profiles to associate with the participants. Roles for users (1.1a), for coordinators (1.1b) and for sponsors (1.1c) are available and these enrollees or participants may be sourced from trust networks (1.2a), social networks (1.2b), professional groups (1.2c), fantasy sports league members or players (1.2d) or other users who may enroll individually or as members of a group. The enrollment process (1.3) includes setting up a configuration profile (1.3a) that defines the assets (1.3a1) to be included, the entities that may have access to historical or current or real time data regarding the assets (1.3a2) and determining what triggers to associate with behavior or performance of the assets (1.3a3). Also included in configurations for entities and extraction methods (1.3b) is the particular one or plurality of extraction methods to use in interaction with the data transmitting entity or purveyor (1.3b1) and the server actions that could be associated with interaction with the data transmitting entity or purveyor (1.3b2) as well as the interactions that involve payment or other exchanges with the data purveyor or transmitting entity (1.3b3). In addition, the configuration profile can include methods to integrate the data into other data (1.3c) within the data supply chain and identify whether the configuration profile is a default profile (1.3d) and whether it will be propagated to other participants (1.3e) or managed in some other fashion (1.3f). The sponsor (1.1b) or coordinator (1.1c) will drive the method for the configuration process and may adjust rights and roles and rules according to the variation of the embodiment of the invention.

It is expected that variable types of connections and forms of transmission will be used (3) including devices operating as servers and servers themselves (3.1) including NFC devices and sensors (3.1a), Cloud and SaaS servers (3.1b), hard wired networks (3.1c), wireless networks (3.1d) and others connection and transmission devices such as smart phones and tablet computers (3.1e). These devices will be associated with one or a plurality of data transmitting entities (3.2) such as a data aggregator (3.2a), a data federator (3.2b), a media outlet or producer (3.2c), a commercial data producer such as a research firm or statistical analysis enterprise (3.2f), a social network data producer such as a member of a social network streaming data from their camera to a media storage or processing intermediary (3.2g), a data storage entity (3.2h), a data generation entity (3.2i), an originating server that produces data or measurement (3.2j) a social network vendor such as Facebook or Yahoo (3.2k), or any other entity 3.2l).

Entities receiving the data (3.3) are servers (3.3a) or devices (3.3b) or display screens (3.3c) linked to transmitting servers or devices (3.1) and may be configured to specifically receive transmissions of mashup or dashboards or other display formats relevant to the scenario or simulation. When participants are connected to data transformation and processing (B) from devices and entities (A) data operations and transaction processing can be implemented. Streamed data or static data (2.1) can be in alternative formats such as alphanumeric (2.1a), Audio streams (2.1b), video streams (2.1c) or any of the plethora of codecs and other data formats (2.1d). But this data must be subjected to parsing for matches to the assets indicated in the configuration profile (1.3a) and subject to the instructions within the configuration profiles (1.3b). Included and expected data parsing processes and tools (2.2) are use of natural language parsers (2.2a), codec translation and decryption parsers (2.2b), alternative data format decryption parsers (2.2c), hybridized data decryption parsers (2.2d) and other parsers and decryption tools (2.2e).

Trigger construction and revision (2.3) begins with the setting of trigger conditions (2.3a) including setting default threshold values (2.3b) and conditional threshold values that kick in when a certain condition for an asset is achieved (2.3c). The time frame for the trigger to be in force or active is then input (2.3d) and a tag for which server actions would be initiated (2.3e) as the trigger is implemented completes this stage.

When an asset needs to be reallocated the configuration profile needs to be adjusted (2.4). First, the configuration profile needs to be loaded and opened (2.4a) in order to enable edits to be entered and posted and accepted (2.4b). Then the edited or revised configuration profile needs to propagated (2.4c) and servers that implement the configuration profile need to connect to the display devices or screens to adjust the posting and displays (2.4d) and confirmations or notifications need to be posted upon or displayed within the display screens (2.4e) for participants to confirm that the changes have been implemented.

Interaction with data mashups and display (2.5) can take multiple forms, including the posting or embedding of advertisements or informative messages into dashboards (2.5a) and streamed or static mashups (2.5b) or evocation of natural language processing interface to announce events or accept comments from participants as audio messages (2.5c) or accept hand gestures or motions such as swipes or finger taps and other indicators of participant responses (2.5d). Dependent upon the scenario or simulation other kinds of display such as control panel displays can be enabled (2.5e). As operations and processing are connected to transactions (C) some of the immersive potential and the implementation of the business methods and procedures for the invention become more apparent. To facilitate transactions (4) such as payments and fees (4.1) fee schedules and other payment methods such as subscriptions or application download fees and so forth (4.1a) are implemented in accordance with terms and schedules for payments (4.1b) and instructions or arrangements for electronic payment or other payment methods are implemented (4.1c) along with other API's being invoked to track transactions and post and record them (4.1d). Notifications and posts (4.2) are also made and some of these will initiate transactions and posts upon NFC devices (4.2a) or connect to social networks to make posts into files associated with network members (4.2b) and logging of activities and events and actions performed by the system (4.2c) will be made upon at least one server capable of storing data. Further actions and posts such as the transmission of Email, SMS, and other notification and messaging processes (4.2d) will also be implemented and logged along with other server actions and events (4.2e) set up or enabled or allowed by the coordinators or sponsors of the scenario or simulation or game.

Electronic transactional handshake(s) (4.3) and the cycle of automated payments and other transactions (4.3a) and maintenance of transaction logs (4.3b) and recording and storage of confirmations of transactions (4.3c) will be implemented through the invention as well as enabling and recording other transactions involving servers or devices that may be directly included in processes for exchanges of fees and payments, or involved in the distribution or propagation of configuration profiles, or involved in the posting or distribution of data or mashups resulting from triggers or other server or device actions or events derived from configuration instructions (4.3d).

While FIG. 1 is illustrative of the system and method of the invention disclosed herein, those skilled in the art will understand that a plurality of alternative embodiments are to be expected that are within the scope or are encompassed by the art represented through the claims of the invention.

To summarize the invention, it leverages pervasive computing through including participants enrolled into scenarios through devices linked to their enrollment status. A subset of participants are designated as a sponsor or coordinator with rights to assign or delegate rights or rules or roles or access to operations of the system and method of the invention to monetize, administer, and or improve or adjust a scenario. Sponsors may delegate rights to make changes to rules and roles. Participants can be enrolled through social networks or crowd sourcing methods provided devices or servers associated with participants are linked and registered as well in order to transmit or receive streams of digital information and to executing computer readable code. A display device for mashups is also necessary for the invention to operate properly and NFC enabled devices will further enrich the experience of participants.

The scenario will include rules processes and conditions that specify distribution or allocation of assets. These assets may include various combinations of digital and real word objects or persons or instruments, such as avatars in a computerized game, rosters of players within a sports league, equipment assigned to a military unit including robotic devices, multiple types of financial instruments, medical equipment or medications allocated to clinical trials. The rules and processes will also specify rights and roles for making changes to attributes or values assigned to assets or strategies or tactics. These changes to assets or to attributes or values may be propagated to other participants.

A feature of particular importance is generation of real time streamed data by entities external to the scenario participation schema. Streamed data may be generated by NFC enabled devices such as medical diagnostic equipment or tablet computing devices or smart phones, and military tools and weapons equipped with NFC capability including robots. The real time streamed data may include video or audio or alphanumeric data from a variety of data providers or vendors such as repositories of statistical data, media outlets transmitting sporting events, commodity or stock market transaction streams, transactions occurring within or across financial institutions or businesses, updated aggregations of data from near field communications devices, or data streamed from military equipment. Real time and other data may be combined or conflated with historical or statistical data depending on the scenario configuration and participants may have rights to process data from real time data streams as well as statistical or historical data.

Participants can configure triggers or subroutines that are responsive to changes in data associated with assets assigned to them and to events and actions occurring within a scenario. These triggers may be generated, propagated, and implemented in accordance with rules and rights assigned to other participants and roles within a scenario. As data changes in real time, if a trigger condition is achieved, a trigger will initiate events or actions or subroutines or API's or other computer codeable forward chains or backward chains according to instructions associated with the trigger. Rules and rights for construction of triggers may vary according to the role of the participants in a scenario. Triggers may be developed by the coordinator of a scenario and distributed through devices.

The display of mashups of video or audio or other data streams associated with assets assigned to participants and viewable upon screens or playable through speakers linked to the devices accessible to the participant provides the context for the participant to actively engage in managing assets included into the scenario. The immersive experience of the participant changing configuration profiles and adjusting trigger conditions and formulae according to real time data is the most significant benefit of the invention described herein and will result in improved decision making for those who use it.

1. A system and method for acquiring and linking a plurality of sections or segments of data regarding assets from a plurality of data transmission or streaming entities via servers linked to members of one or a plurality of social networks, media outlets, data federators, data aggregators, data producers, data storage entities, and data generation devices;
said data regarding assets originated upon and distributed via one or a plurality of originating servers and distributed to one or a plurality of users comprising the steps of;
accessing by one or more first users computer readable code from a server, wherein each user builds a configuration profile or invokes a default configuration profile designating which one or a plurality of servers associated with said one or a plurality of data streaming, data transmission, data federation, data aggregation, data warehousing, or statistical tabulation and storage entities are to be linked into a data supply chain associated with said first user;
including within said configuration profile instructions by default or from said user for a preferred sequencing or priority for observation of said one or a plurality of streams of data streamed by said one or a plurality of data streaming or transmission entities for identifying information associated with one or a plurality of assets included into a scenario or simulation;
including within said configuration profile instructions for implementation of one or a plurality of parsing methods including natural language processing parsers wherein said configuration profile designates one or more alphanumeric data strings identifying one or a plurality of assets to match against one or more alphanumeric data strings within said plurality of streams of data;
including within said configuration profile by default or by said user the designation of a length of a section or segment of a data stream or dataset or data table preceding and/or following discovery of a match with said alphanumeric data string identifying one or a plurality of assets to extract or copy from said data stream or data set or data table to transmit or post upon a server or device associated with said user;
including within said configuration profile by default or by said user the designation of a time frame of a section or segment of a data stream preceding and/or following discovery of a match with said alphanumeric data string identifying one or a plurality of assets to extract or copy from said data stream to transmit or post to a server or device associated with said user;
including within said configuration profile by default or by user selection a choice of one or a plurality of mashup algorithms, codecs, or languages to apply to said section or segment of one or a plurality of data streams identifying one or a plurality of assets to convert said section or segment to one or a plurality of data formats readable by a server or device associated with said user;
including within said configuration profile one or a plurality of GUI's for designing triggers for actions to be performed by the server responsive to said readable data incoming identifying one or a plurality of assets to said server;
including within said configuration profile, and connected to said one or a plurality of GUI's, one or a plurality of trigger logic formulae for actions to be performed by the server, wherein said configuration profile offers default logic formulae for said trigger conditions;
including within said configuration profile and responsive to calculations implemented by said one or a plurality of trigger logic formulae, one or a plurality of trigger conditions for actions to be performed by said server, wherein each configuration profile offers default threshold values for said trigger conditions or said user sets one or a plurality of threshold values for said one or a plurality of trigger conditions;
including within said configuration profile one or a plurality of fee or payment offers or terms for one or a plurality of extracted section or segment of one or a plurality of data streams regarding one or a plurality of assets;
including within said configuration profile one or a plurality of fee or payment processes and methods for one or a plurality of extracted section or segment of a data streams regarding one or a plurality of assets;
observing by the server associated with said user intermittently or continuously the one or a plurality of streams of data or datasets or data tables for one or a plurality of sections or segments of streams of data that match said one or more alphanumeric data strings regarding one or a plurality of assets;
extracting by the server associated with said user the one or a plurality of streams, one or a plurality of sections or segments from streams of data or datasets or data tables that match said one or more default configuration settings or one or more settings regarding one or a plurality of assets designated by said user;
transmitting or posting by the server said matched extracted one or a plurality of sections or segments of data regarding one or a plurality of assets to an electronic display device associated with said user;
comparing said one or a plurality of sections or segments of data regarding one or a plurality of assets against said one or a plurality of trigger conditions;
initiating server actions based upon the one or more attained trigger conditions; and
outputting actions by the server in an iterative loop until all the attained trigger conditions have been serviced.

2. The system and method of claim 1, wherein one or more of said user configuration profiles may be propagated through a user network of linked or associated servers, such as a social network, trust network, professional group, members of fantasy sports league, or other entities or networks capable of accessing data, processing data, streaming data, or housing data.

3. The system and method as in claim 1 wherein one or more of said default user configuration profiles are propagated to said one or a plurality of servers associated with data transmission or streaming or storage or federating or aggregating entities to identify whether said data transmission or streaming or storage or federating or aggregating entities have data stored or coming online through live data transmission that correlates with data sections or segments regarding one or a plurality of assets in a default user configuration profile.

4. The system and method as in claim 1 wherein at least one or more servers or devices associated with a user can propagate said default configuration profiles to said one or a plurality of servers associated with data transmission or streaming or storage or federating or aggregating entities to identify whether said data transmission or streaming or storage or federating or aggregating entities have data stored or coming online through live data transmission that correlates with one or a plurality of assets included in a user's default configuration profile.

5. The system and method of claim 1 wherein a second user associated with one or a plurality of servers associated with data transmission or streaming or storage or federating or aggregating entities responsive to said first user's configuration profile is enabled to provide permission to implement actions through said servers associated with said data transmission or streaming or storage or federating or aggregating entities;
including extraction of one or a plurality of sections or segments data regarding one or a plurality of assets from data transmission and data streams unique to said first user's default configuration profile;
including implementation of one or a plurality of links or handshakes across one or a plurality of servers of said data transmission or streaming or storage or federating or aggregating entities and one or a plurality of servers associated with said first and second users;
including said second user of one or a plurality of servers associated with data transmission or streaming or storage or federating or aggregating entities indicating acceptance of terms for extraction or copying of sections or segments of streamed data regarding one or a plurality of assets; and
including authorizing electronic payments or banking transactions from said first user to one or a plurality of data transmission or streaming or storage or federating or aggregating entities according to terms within the configuration profile of said first user.

6. The system and method of claim 1 wherein one or a plurality of said server actions may be to post an indicator or notification regarding one or a plurality of assets upon an electronic device or server associated with a user to announce the attainment of the one or a plurality of trigger conditions upon observation of attainment of said trigger conditions via one or a plurality of methods;
including one or more of an audio enabled natural language processing interface;
implementing a change upon the screen display of the one or a plurality of devices or servers associated with a user;
implementing a change in the order or sequence or graphic images within said screen display upon a server associated with a user;
implementing one or a plurality of changes to values or images displayed within one or a plurality of dashboards on said screen display of a server associated with a user; or
implementing a change in the presentation or configuration of mashups of the one or a plurality of sections or segments of data posted or displayed upon one or a plurality of servers associated with a user.

7. The system and method of claim 1 wherein a user may allow an electronic device capable of processing computer readable code or a device capable of using a natural language processing interface, gestures or motions, or other communication methods in active communication with said server to accept implementation of one or a plurality of triggered server actions, or may elect to override implementation of the said one or a plurality of triggered server actions.

8. The system and method of claim 1 wherein an override of said one or a plurality of triggered server actions opens said user's configuration profile for editing or changes by a user upon one or a plurality of servers associated with a user's configuration profile.

9. The system and method of claim 1 wherein one or a plurality of triggers regarding one or a plurality of assets for server actions may be included into said configuration profile;
including triggers initiated prior to or during or following a game or a scenario or simulation for contract offers to potentially available assets, participation in auctions of assets, participation in draft processes for assets, changes to rosters or lineups of assets, assignments or assets to positions or roles within the scenario or game or simulation;
including triggers upon attainment of stage or status of play with the scenario or game or simulation;
including triggers for side bets and for bonuses or rewards;
including triggers for placement of ads into data streams upon events or stages of game play, placement of ads into data streams according a participant's historical participation, placement of ads into data streams according to the demographic data
including triggers for scenario or simulation of league game rule changes, events related to the status of the field or playing environment, results of side bets, reward or prize distributions and assignments;
including triggers for calculation of fees or charges for membership or participation, for calculation of fees or charges for ad placement, and for initiation of fund transfers across financial institutions of fees and charges.

9. The system and method of claim 1 wherein a user may be a non-human entity such as a robot or an artificial intelligence algorithm or series or algorithms.
